(19) United States
(12) Patent Application Publication
(10) Pub. No.: US 2018/0140134 A1
(43) Pub. Date: May 24, 2018

(54) BARBEQUE/GRILLING UTENSIL CARRYING KIT

(71) Applicant: William Braddy, JR., Florence, SC (US)

(72) Inventor: William Braddy, JR., Florence, SC (US)

(21) Appl. No.: 15/681,575

(22) Filed: Aug. 21, 2017

Related U.S. Application Data
(60) Provisional application No. 62/424,841, filed on Nov. 21, 2016.

(51) Int. Cl. A47J 37/07; A47J 43/28

(52) U.S. Cl. CPC A47J 37/0786; A47J 43/288

(57) ABSTRACT

A configurable case holds utensils useful for cooking on an outdoor grill and comprises a case having an interior and an exterior, with a first interior side and a second interior side, the first interior side comprised of a plurality of loop retainers reconfigurable to secure cooking accessories. The plurality of loop retainers comprises at least a first designated area for securing at least a first type of container, a second designated area for securing at least a second type of container, and a third designated area for securing at least one cooking utensil. The second side comprises at least a fourth designated area that includes at least a pocket for receiving a cooking accessory.

### CROSS-REFERENCE TO RELATED APPLICATION(S)

This application claims priority from U.S. Provisional Application 62/424,841 filed Nov. 21, 2016, which is incorporated herein.

### BACKGROUND OF THE INVENTION

### 1. Field of Invention

The present invention relates to the field of kitchen utensil kit, more particularly to a kit for transporting and using cooking utensil designed for outdoor grilling, including organizing a plurality of utensil and cooking supplies for use at an outdoor grill in a user friendly protective carrying kit.

### 2. Description of Related Art

The invention is directed to a barbecue utensil kit for transporting and organizing kitchen utensils for use at an outdoor grill. The kit is designed for secure storage and carrying of all the essential utensils, sauces, and spices and other barbecuing items and supplied for cooking on an outdoor grill.

The invention relates generally to outdoor cooking accessories and in particular to a barbecue/grilling utensil kit. At back yard gatherings and tailgate parties, the outdoor grill and its freshly cooked products, such as barbeque, are an integral feature. Unfortunately, keeping the utensils, spices, and other barbecuing items organized can be difficult. Tabletop or counter space can be limited or nonexistent. Mud, wind, and rain often create adverse conditions and due to high cooking temperatures, time can be critical and require grabbing the right utensil. The grill chef needs to be able to secure whatever is needed immediately and reliably. Various pocketed aprons and other devices have been developed, but each has proven to be unsatisfactory in its own way. A barbecue utensil kit, which is completely self-contained, secure, easily carried with one hand, and complete without including any unnecessary items, and with easily accessible storage, would resolve these problems.

Conceptionally, the grilling utensil kit is similar to a small, soft-sided suitcase, opening in a clamshell fashion with a two-part flexible handle, and joined together with a wrap-around hook and loop closure. The front half of the kit provides a series of basic utensils, a marinade spray bottle and a plurality of small spice jars all of which are easily refilled, secured to the interior surface of the front half with a series of specially-sized elastic loops. The rear half of the kit provides a large, elastic mesh interior pocket for the storage of a plastic or metal tray that holds grilled items once they are removed from the grill. The exterior surface of the rear half provides an exterior pocket, also manufactured from elastic mesh, for the storage of additional items, such as multiple barbeque sauce bottles, and can include elasticized pouches sized for a several small refillable plastic bottle holding barbeque or other sauces.

Based on the foregoing, there is a need in the art a system, which will facilitate carrying and using grilling cooking utensil and supplies.

### SUMMARY OF THE INVENTION

In an embodiment, a configurable case holds utensils useful for cooking on an outdoor grill and comprises a case having an interior and an exterior, with a first interior side and a second interior side, the first interior side comprised of a plurality of loop retainers reconfigurable to secure cooking accessories. The plurality of loop retainers comprises at least a first designated area for securing at least a first type of container. The plurality of loop retainers comprises at least a second designated area for securing at least a second type of container. The plurality of loop retainers comprises at least a third designated area for securing at least one cooking utensil. The second side comprising at least a fourth designated area that includes at least a pocket for receiving a cooking accessory.

In an embodiment, the plurality of loop retainers are reconfigurable using a plurality of fasteners comprising at least one of a loop and hoop fastener or a snap.

In an embodiment, the second side further comprises a plurality of horizontally orientated loop retainers forming storage slots and reconfigurable to accommodate a plurality of items.

In an embodiment, the plurality of loop retainers are reconfigurable using fasteners comprising at least one of a loop and hoop fastener or a snap.

In an embodiment, the first interior side and the second interior side comprises a rigid, separate, removable rigid structure, said structure made from a material selected from the group comprising plastic, stainless steel, and aluminum.

In an embodiment, the type of containers are selected from a group comprising a jar; a bottle; and a spray bottle.

In an embodiment, the cooking utensil comprises at least one of 1) a spatula; 2) a pair of tongs; and 3) a basting brush.

In an embodiment, the cooking accessory comprises at least a rigid, heat resistant tray.

In an embodiment, the exterior comprises a soft, pliant heavyweight synthetic fiber cloth.

In an embodiment, the exterior comprises a hard plastic or metal.

In an embodiment, the exterior comprises an exterior pocket.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a top perspective view of the first exemplary embodiment in an opened position, displaying the barbeque/grilling utensil kit 10, the front half 11, the rear half 12, the handle halves 14, the hook and loop closure 15, the spice jars 16, the spray bottle 17, the tongs 18, the spatula 19, the elastic loops 20, and the interior pocket 21, according to an embodiment of the present invention;

FIG. 2 is a top view of the first exemplary embodiment, displaying the barbeque/grilling utensil kit 10, the front half 11, the rear half 12, the handle 13, the handle halves 14, and the hook and loop closure 15 in a closed configuration, according to an embodiment of the present invention.

FIG. 3 is a front perspective view of the first exemplary embodiment, displaying the barbeque/grilling utensil kit 10, the front half 11, and the handle 13, according to an embodiment of the present invention;

FIG. 4 is a rear view of the first exemplary embodiment, displaying the barbeque/grilling utensil kit 10, the rear half 12, the handle 13, and the exterior pocket 22, according to an embodiment of the present invention;

FIG. 5 is a front view of the first exemplary embodiment, displaying the barbeque/grilling utensil kit 10, the front half 11, and the handle 13, according to an embodiment of the present invention;

FIG. 6 is a top view of the first exemplary embodiment in an opened position, displaying the barbeque/grilling utensil kit 10, the front half 11, the rear half 12, the handle halves 14, the hook and loop closure 15, the spice jars 16, the spray bottle 17, the tongs 18, the spatula 19, the elastic loops 20, and the interior pocket 21, according to an embodiment of the present invention; and

FIG. 7 is a side view of the first exemplary embodiment, displaying the barbeque/grilling utensil kit 10, the front half 11, the rear half 12, the handle 13, and the small pocket 22, according to an embodiment of the present invention.

### DETAILED DESCRIPTION OF PREFERRED EMBODIMENTS

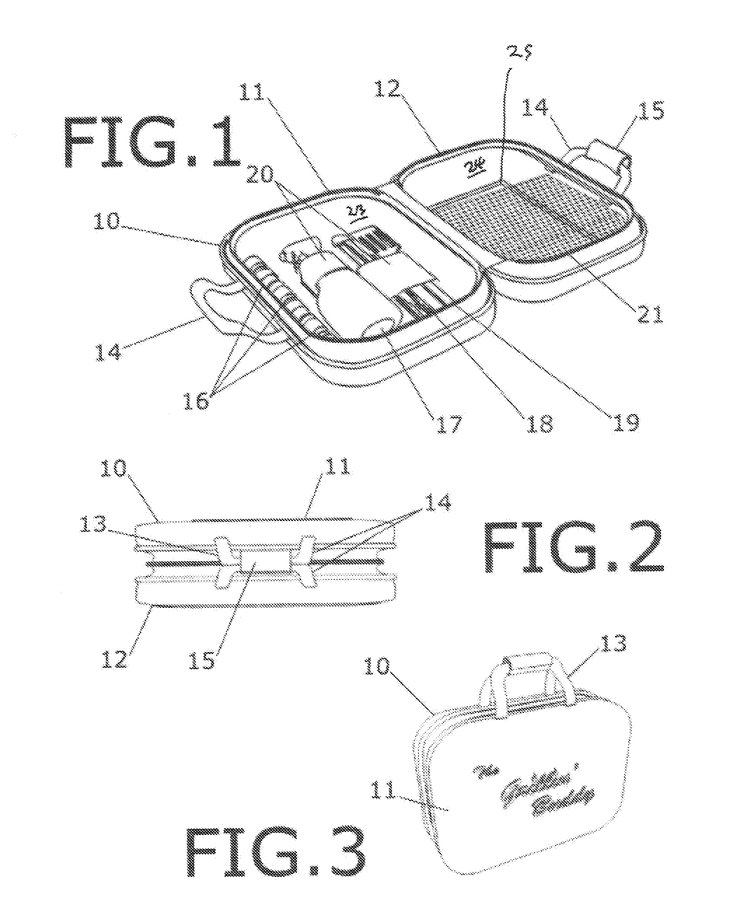

Preferred embodiments of the present invention and their advantages may be understood by referring to FIGS. 1-7, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows a first exemplary embodiment of an open barbeque/grilling utensil kit 10 in the opened position showing a front half 11 and a rear half 12. Handle halves 14 can match together when barbeque/grilling utensil kit 10 is closed, and the hook and loop closure 15 can secure the kit 10 in the closed position. The spice jars/barbeque sauce containers 16, the spray bottle 17, the tongs 18, the spatula 19, the elastic loops 20, and the interior pocket 21 are all components.

The barbeque/grilling utensil kit 10 can be comprised of a heavyweight synthetic fiber cloth case or hard-sided plastic or metal, which is similar to a small suitcase, opening in a clamshell fashion with a two-partially flexible handle 13 (refer to FIG. 2), comprised of two handle halves 14 that can join together with a wrap-around hook and loop closure 15, such as Velcro®. Alternate designs for the handle 13 are contemplated. The clamshell case can also be secured by a zipper in an embodiment of a cloth case or a latch in an embodiment of a metal or plastic case. The front half 11 of the barbeque/grilling utensil kit 10 provides a series of basic utensils such as tongs 18 and a spatula 19, a small plastic/metal, heat resistant tray 25, and a plurality of small spice jars/sauce containers 16 which are easily refilled, with items secured to the interior surface of the front half 11 with a series of specially-sized hook and loop straps/retainers 20. Preferably, the utensils in the first exemplary embodiment are comprised of a spray bottle 17, tongs 18, and a spatula 19.

The hook and loop straps/retainers 20 may themselves be removably affixed to the interior surface 23 of the front half 11, using hook and loop fasteners, metal snaps or other closures, such that the user may rearrange them, or modify the combination of stored utensils, as desired. Alternate embodiments, which may provide a different combination of utensils and may include a basting brush, are also contemplated.

In an embodiment, interior surfaces 23 and 24 can comprise either the same material as the exterior of barbeque/grilling utensil kit 10, as an integrated part of barbeque/grilling utensil kit 10, or surfaces 23 and 24 can comprise separate and removable rigid structure, such as plastic, stainless steel, or aluminum, which can be removed from a cloth case structure to facilitate cleaning. The interior elastic loops 20 as well as elasticized loops securing spice jars/barbeque sauce containers 16 can be removable as well to facilitate cleaning.

In an embodiment, the rear half 12 of the kit 10 provides a large, elastic mesh interior pocket 21 for the storage of items provided by the user, such as a favorite apron or a bottle of barbecue sauce. The exterior surface of the rear half 12 provides an interior small mesh pocket 22, also manufactured from elastic mesh, for the storage of additional items. In an embodiment, this can include a rigid tray 25. The interior pocket 21 and exterior pocket 22 can be made from elastic mesh can encompass the entire rear half 12. The interior mesh pocket 21 can encompass a portion (as depicted) or an entirety of interior 24. Rear half 12 can also incorporate elastic loops running horizontally to form different sized storage slots to receive other items, such as matching-sized plastic containers for sauce, salt, pepper, or other seasonings as desired by a chef, and these storage loops can be part of the interior of interior mesh pocket 21. Both the interior pocket 21 and the exterior pocket 22 may include a drawstring, hook and loop fasteners, metal snaps, or similar closures to further secure items stored therein. In some embodiments, the pockets 21 and 22 can comprise a solid fabric rather than a mesh.

FIG. 2 shows a top view of an embodiment of the barbeque/grilling utensil kit 10, the front half 11, the rear half 12, the handle 13, the handle halves 14, and the hook and loop closure 15 in a closed configuration. The two-partially flexible handle 13 as depicted are joined together and comprised of two handle halves 14 joined with a wrap-around hook and loop closure 15, such as hook and loop fasteners (i.e., Velcro®).

FIG. 3 is a front perspective view an exemplary embodiment of the barbeque/grilling utensil kit 10, the front half 11, and the handle 13.

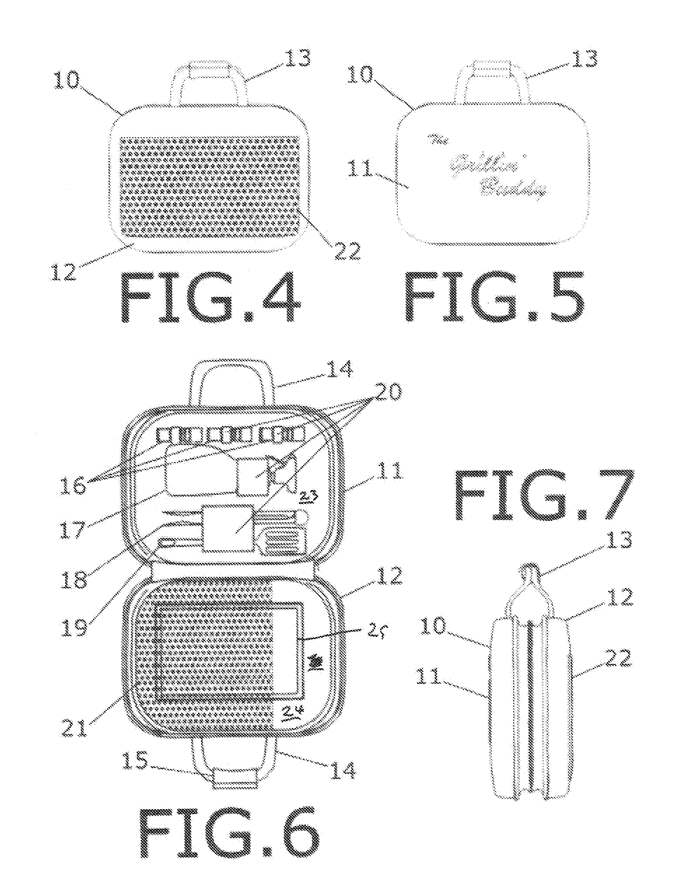

FIG. 4 is a rear view of an embodiment depicting the barbeque/grilling utensil kit 10, the rear half 12, the handle 13, and small mesh pocket 22. Pocket 22 can encompass the entire exterior rear surface rear half 12.

FIG. 5 is a front view of an embodiment depicting the barbeque/grilling utensil kit 10, the front half 11, and the handle 13.

FIG. 6 is a top view of an exemplary embodiment in an opened position depicting the barbeque/grilling utensil kit 10, the front half 11, the rear half 12, the handle halves 14, the hook and loop closure 15, the spice jars/barbeque sauce containers 16, the spray bottle 17, the tongs 18, the spatula 19, the elastic loops 20, the interior pocket 21, the rigid tray 25, and the front interior 23 and the rear interior 24.

FIG. 7 is a side view of an embodiment depicting the barbeque/grilling utensil kit 10, the front half 11, the rear half 12, the handle 13, and the exterior pocket 22, according to an embodiment of the present invention.

To use an embodiment as depicted, the user pulls the product out of the elastic loop closure 15 on the handle 13, separates the handle halves 14, and opens the kit 10 such that the exterior surfaces of the front half 11 and the rear half 12 are laying flat on a tabletop, a counter, the ground, or a similar horizontal surface. The user may then store or remove large items, such as an apron or a bottle of barbecue sauce, in the interior pocket 21. The user may select one or more utensils and spice jars/barbeque sauce containers 16 for use, Elastic loop bands 20 can secure the selected utensils, marinade spray bottle and spice jars/barbeque sauce containers 16, and a user can remove the desired utensils, spray bottle/spice jars/barbeque containers 20, and can replace them when finished.

In an embodiment, the front half 11, the rear half 12, the tongs 18, and the spatula 19, marinade spray bottle and tray are preferably manufactured from a rigid, durable material which is heat resistant and corrosion resistant, such as aluminum alloy or stainless steel. The handle halves 14, the hook and loop closure 15, and the hook and loop straps holding spice jars/barbeque sauce containers 16 can be preferably manufactured from a flexible, durable material which provides substantial tensile strength, such as nylon fabric or nylon webbing, or other synthetic material.

The spice jars/barbeque sauce containers 16 and the spray bottle 17 can be preferably manufactured from a rigid, durable material which is transparent or translucent, such as plastic, providing lids which are preferably manufactured from a rigid, durable material such as plastic or aluminum alloy. The interior pocket 21 and the exterior pocket 22 are preferably manufactured from a flexible, durable material which is elastic, such as nylon mesh or elasticized cotton. Components, component sizes, and materials listed above are preferable, but artisans will recognize that alternate components and materials could be selected without altering the scope of the invention.

In an embodiment, the barbeque/grilling utensil kit 10 typically can be sized so as to house and secure two grilling utensils such as an 11.5″ stainless steel tong, an 11.5″ stainless steel spatula, and an 11″×9″ plastic or metal heat resistant tray.

In an embodiment, the case is similar to a laptop case in size and appearance, with approximate dimensions of 17″ wide (left to right) and 14″ height (top to bottom). When opened, the interior sides include elastic loop straps designed to house and secure the tongs 18 and spatula 19. Also, on the left interior side of the case there can be an elastic loop strap designed to hold and secure a standard marinade bottle 17, an elastic loop strap designed to hold and secure a set of utensils, tongs 18 and spatulas 19, and to the far left interior can be three elastic loop straps designed to house and secure standard plastic seasoning bottles or plastic containers for barbeque sauce 16. The elastic loops can be reconfigurable facilitated by integrated snaps, Velcro® fasteners, and the like, so as to be accommodate different sized items, or containers, such as jars or bottles.

In an embodiment, inside the case on the right side, there can be an interior pocket 22 large enough to house and secure an 11″×9″ heat resistant tray 25. The case of barbeque/grilling utensil kit 10 can comprise a soft, pliant cloth construction and include a zipper beginning on the lower left side of the case coming up to the top to unzip across the top from left to right then down to the right corner of the case. This allows the case to lay flat on any hard surface. The advantage of the case lying flat provides easy access to the grilling utensils and accessories.

In an embodiment, on the back side of the case, there can be an exterior pocket 22 designed to hold additional items such as a lighter, additional seasonings, a small flashlight, small towel, or small Bluetooth® speaker. The case can be slightly rounded at the corners and made of soft, pliable or hard, rigid material. The case can have soft flexible handles for carrying.

The disclosed invention can offer the following advantages. It can prevent multiple trips in and out the house to an outdoor grill. For a tailgating event, all one needs to do is grab the barbeque/grilling utensil kit 10 before leaving the house. The same applies for a camping trip, going on vacation, or going to any outdoor grilling situation.

Advantages:

The case includes a designated area to house sized to fit a standard marinade bottle (e.g., spray bottle 17).

The case can also include a designated area to house 2-3 standard seasoning jars or plastic bottles 16 with configurable elastic straps that can be removed or resized to accommodate various sized containers including either seasoning jars or small plastic bottles containing barbeque sauces, such as small refillable plastic bottles. The interior can accommodate several such containers in the front half 11 and the rear half 12 in elasticized loop retainers, and in some embodiments these loop retainers can be reconfigured and resized to facilitate storing/securing different size containers facilitated by integrated snaps, Velcro® fasteners, and the like.

The case can also have a designated area storing a heat resistant plastic or metal food tray 25 to place cooked food on after being grilled. The interior pocket 21 or the exterior pocket 22 can be used for this purpose. The interior pocket 21 can be preferred, as this location can keep the tray 25 clean and sanitary.

The elastic mesh pocket on the backside (21) and on the outside (22) of the case can be designed to house miscellaneous items such as additional seasonings, a lighter to light the grill, a small towel to clean the cooking area, a small Bluetooth® speaker, matches, and a small flashlight. The interior surface of the interior pocket 21 and exterior pocket 22 can additional comprise reconfigurable elastic loops to accommodate multiple, different sized containers or other objects.

The case also can also include a designated area to house a tong 18 and spatula 19.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A configurable case holding utensils useful for cooking on an outdoor grill, comprising:
a case having an interior and an exterior, with a first interior side and a second interior side, the first interior side comprised of a plurality of loop retainers reconfigurable to secure cooking accessories;
wherein the plurality of loop retainers comprises at least a first designated area for securing at least a first type of container;
wherein the plurality of loop retainers comprises at least a second designated area for securing at least a second type of container;
wherein the plurality of loop retainers comprises at least a third designated area for securing at least one cooking utensil; and
the second side comprises at least a fourth designated area that includes at least a pocket for receiving a cooking accessory.

2. The configurable case of claim 1, wherein the plurality of loop retainers are reconfigurable using a plurality of fasteners comprising at least one of a loop and hoop fastener or a snap.

3. The configurable case of claim 1, wherein the second side further comprises a plurality of horizontally orientated loop retainers forming storage slots and reconfigurable to accommodate a plurality of items.

4. The configurable case of claim 3, wherein the plurality of loop retainers are reconfigurable using fasteners comprising at least one of a loop and hoop fastener or a snap.

5. The configurable case of claim 1, wherein the first interior side and the second interior side comprises a rigid, separate, removable rigid structure, said structure made from a material selected from the group comprising plastic, stainless steel, and aluminum.

6. The configurable case of claim 1, wherein the type of containers are selected from a group comprising:
a jar;
a bottle; and
a spray bottle.

7. The configurable case of claim 1, wherein the cooking utensil comprises at least one of—
1) a spatula;
2) a pair of tongs; and
3) a basting brush.

8. The configurable case of claim 1, wherein the cooking accessory comprises at least a rigid, heat resistant tray.

9. The configurable case of claim 1, wherein the exterior comprises a soft, pliant heavyweight synthetic fiber cloth.

10. The configurable case of claim 1, wherein the exterior comprises a hard plastic or metal.

11. The configurable case of claim 1, wherein the exterior comprises an exterior pocket.
